(19) United States
(12) Patent Application Publication
(10) Pub. No.: US 2008/0223850 A1
(43) Pub. Date: Sep. 18, 2008

(54) HEAT EXCHANGING APPARATUS

(75) Inventor: Junji NAKAO, Takatsuki-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 12/044,450

(22) Filed: Mar. 7, 2008

(30) Foreign Application Priority Data
Mar. 14, 2007 (JP) P2007-065348

(51) Int. Cl. H05B 6/04

(52) U.S. Cl. 219/618

(57) ABSTRACT

A heat exchanging apparatus includes a heat generating tube of spiral form through which pure water flows, a short-circuit member for electrically short-circuiting ends of the heat generating tube, and a heating coil arranged to envelope the heat generating tube and the short-circuit member, for generating an electromagnetic induction power to heat the heat generating tube. The short-circuit member generates a short-circuit current according to the electromagnetic power and temperature-adjusts the heat generating tube. The heat generating tube adjusts the temperature of the pure water so that the temperature of the pure water flowing through the tube becomes a target temperature according to the temperature adjustment effect of the short-circuit current. In the apparatus, the flow-in port of the heat generating tube is grounded to earth to discharge electrification charges of a residual particle component related to the pure water, and fine the residual particle component.

This application claims priority from Japanese patent application P2007-065348, filed on Mar. 14, 2007. The entire contents of the aforementioned application is incorporated herein by reference.

### BACKGROUND OF THE INVENTION

1. Field of the Invention

The present invention relates to a heat exchanging apparatus for temperature-adjusting chemical solution such as ultrapure water and chemical gas used in the manufacturing process of semiconductor substrates, liquid crystal substrates, and the like to a target temperature through heat exchanging effect.

2. Description of the Related Art

Conventionally, a circulator type heat exchanging apparatus for adjusting the temperature of a chemical solution by circulating the chemical solution between a constant temperature liquid tank and a processing liquid tank using a heating device and a cooling device as disclosed in, Japanese Utility Model Publication Laid-Open No. 6-12394 is widely used as the heat exchanging apparatus.

The heat exchanging apparatus of Japanese Utility Model Publication Laid-Open No. 6-12394 relates to a heat exchanging apparatus for executing a processing liquid circulating process of returning the chemical solution supplied from the processing liquid tank back to the processing liquid tank through the constant temperature liquid tank containing constant temperature liquid, and adjusting the temperature of the chemical solution through temperature control of the constant temperature liquid contained in the constant temperature liquid tank, the heat exchanging apparatus including a heating device, arranged in the constant temperature liquid tank, for heating the constant temperature liquid; a cooling device, arranged exterior to the constant temperature liquid tank, for performing cooling control so that the constant temperature liquid becomes a predetermined temperature; a constant temperature liquid circulating device for circulating the constant temperature liquid between the cooling device and the constant temperature liquid tank; a valve, arranged on the constant temperature liquid circulating path, for switching the necessity of circulating the constant temperature liquid; a temperature detection device for detecting the temperature of the chemical solution to be circulated; and a switch control device for controlling the valve and the heating device according to the detected liquid temperature of the temperature detection device and switch controlling the constant temperature liquid circulation and the constant temperature liquid heating.

According to the heat exchanging apparatus of Japanese Utility Model Publication Laid-Open No. 6-12394, the circulation of constant temperature liquid or the heating of constant temperature liquid of the constant temperature liquid tank is switched and selected according to the temperature of the chemical solution, and the chemical solution to be circulated between the constant temperature liquid tank and the processing liquid tank is indirectly temperature-controlled, so that the chemical solution is temperature-controlled with high responsiveness and high accuracy.

However, according to the circulator type heat exchanging apparatus of Japanese Utility Model Publication Laid-Open No. 6-12394, the power density is high in the heating device and heating adjustment of the chemical solution cannot be carried out in units of 1° C., and thus after once lowering the temperature of the chemical solution to the heating adjustment control temperature region of the heating device with the cooling device, the chemical solution is heated with the heating device to obtain the chemical solution of a target temperature, that is, the chemical solution of the target temperature is obtained by circulating the chemical solution between the constant temperature liquid tank and the processing liquid tank using the heating device and the cooling device, in which case the response is slow since the temperature is adjusted with the circulating effect, and it is extremely difficult to perform high speed and accurate temperature adjustment to raise the temperature of the chemical solution within one section at an error range of lower than or equal to ±0.1° C. when high speed and accurate temperature adjustment is demanded in the case of ultrapure water where temperature adjustment in units of 1° C. is necessary.

According to the circulator type heat exchanging apparatus of Japanese Utility Model Publication Laid-Open No. 6-12394, special devices such as cooling device and constant temperature liquid circulating device need to be installed and thus an installation space for such devices needs to be ensured from a limited space, where in a case where the chemical solution is ultrapure water, power exceeding about 50 KW is required to have the ultrapure water at a constant temperature (18° C.), whereby power consumption of the constant temperature circulating device needs to be ensured in addition to the power consumption of the cooling device, thereby leading to increase in facility cost due to ensuring of installation space and increase in power consumption amount.

In order to deal with the above situation, the applicant proposed a heat exchanging apparatus that realizes a high speed, accurate, and stable temperature adjustment with respect to chemical solution and chemical gas while realizing great reduction in the installation cost by miniaturizing the entire apparatus and reducing the power consumption amount compared to the conventional circulator type heat exchanging apparatus.

A semiconductor washing system related to the heat exchanging apparatus proposed by the applicant will now be described. FIG. 5 shows a block diagram showing a schematic configuration of the inside of the semiconductor washing system.

The semiconductor washing system 1 shown in FIG. 5 includes a washing device 2, internally arranged with a target such as semiconductor substrate and liquid crystal substrate, for washing the surface of the target with ultrapure water; a pure water manufacturing device 3 for manufacturing the ultrapure water for washing the target arranged in the washing device 2; a deairing membrane 4 for separating and removing gas components of the ultrapure water from the pure water manufacturing device 3; a reverse osmosis membrane device 5 for separating and removing ion components of the ultrapure water separated and removed with gas components by the deairing membrane 4 with a reverse osmosis membrane 5A such as acetic ester and polyamide polymer particles; a heat exchanging apparatus 8 for supplying the ultrapure water separated and removed with ion components by the reverse osmosis membrane 5A through a first conduction tube 6, temperature-adjusting the ultrapure water to a target temperature, and supplying the temperature-adjusted ultrapure water to the washing device 2 through a second conduction tube 7; a temperature adjustment unit 9 for setting the target temperature of the ultrapure water; a temperature sensor 10, arranged at the vicinity of the flow-out port of the heat exchanging apparatus 8, for detecting the current temperature of the ultrapure water discharged from the flow-out port; a PLC unit 11 for comparing the current temperature of the ultrapure water detected in the temperature sensor 10 and the target temperature set by the temperature adjustment unit 9, and outputting a voltage pulse corresponding to the heating amount up to the target temperature of the ultrapure water to the heat exchanging apparatus 8 based on the comparison result; and a driver unit 12 for outputting a high frequency power corresponding to the heating amount up to the target temperature of the ultrapure water to the heat exchanging apparatus 8 based on the voltage pulse of the PLC unit 11.

FIG. 6 shows an explanatory view showing a cross sectional structure of the inside of the heat exchanging apparatus 8.

The heat exchanging apparatus 8 shown in FIG. 6 includes a heat generating tube 21 made of electrically conductive material for connecting the first conduction tube 6 and the second conduction tube 7 made of Teflon (registered trademark) and flowing the ultrapure water separated and removed with ion components by the reverse osmosis membrane 5A; a short-circuit member 22 made of nonmagnetic material for electrically short-circuiting the vicinity of a flow-in port (end) 21A and a flow-out port (end) 21B of the heat generating tube 21; a heating coil 23, arranged so as to envelope the heat generating tube 21 and the short-circuit member 22, for generating an electromagnetic induction power with respect to the heat generating tube 21 according to the high frequency power; and a magnetic shield cover 24 for accommodating the heating coil 23; where the heating coil 23 generates a primary side magnetic flux according to the high frequency power, generates a secondary side magnetic flux at the heat generating tube 21 with the primary side magnetic flux, and generates the electromagnetic induction power at the heat generating tube 21 according to the primary side magnetic flux and the secondary side magnetic flux; the short-circuit member 22 generates a short-circuit current according to the electromagnetic induction power of the heat generating tube 21 and temperature adjusts the heat generating tube 21 according to the short-circuit current; and the heat generating tube 21 temperature adjusts the ultrapure water according to the temperature adjustment effect of the short-circuit current so that the temperature of the ultrapure water flowing through the tube becomes the target temperature.

The heat generating tube 21 is configured by a spiral part 21C or a flow path twisted to a spiral form, and has one end connected to the first conduction tube 6 as the flow-in port 21A and the other end connected to the second conduction tube 7 as the flow-out port 21B.

The heat generating tube 21 is made of electrically conductive material such as hastelloy, stainless, inconel, titanium and the like.

The heating coil 23 is configured by coil such as litz wire plate shaped electric wire to suppress epidermal effect. The magnetic shield cover 24 is made of magnetic shield material such as aluminum.

In the reverse osmosis membrane device 5, the ultrapure water is filtered with a UF filter (not shown) after the ion components of the ultrapure water are separated and removed with the reverse osmosis membrane 5A.

FIG. 7 shows an explanatory view showing a schematic configuration of the inside of the heat exchanging apparatus 8, the PLC unit 11, and the driver unit 12 related to the semiconductor washing system 1 from an electrical standpoint.

The PLC unit 11 shown in FIG. 7 includes a temperature comparing part 11A for comparing the current temperature of the ultrapure water detected by the temperature sensor 10 and the target temperature set in the temperature adjustment unit 9, a voltage pulse generating part 11B for generating the voltage pulse corresponding to the heating amount up to the target temperature based on the comparison result of the temperature comparing part 11A, and a voltage pulse outputting part 11C for providing the voltage pulse generated in the voltage pulse generating part 11B to the driver unit 12.

The driver unit 12 includes a rectification circuit 32 for rectifying an alternating current (AC) power from a commercial power supply 31, a smoothing capacitor 33 for smoothing the power rectified in the rectification circuit 32, an auxiliary power supply 34 for supplying the power smoothed in the smoothing capacitor 33 to the entire driver unit 12 as a direct current (DC) power, a high frequency power generating part 35 for generating a high frequency power to be supplied to the heating coil 23 in the heat exchanging apparatus 8, and a drive controlling part 36 for drive-controlling the high frequency power generating part 35, where the drive controlling part 36 detects the voltage pulse corresponding to the heating amount up to the target temperature from the voltage pulse outputting part 11C of the PLC unit 11, and drive-controls the high frequency power generating part 35 to generate the high frequency power corresponding to the voltage pulse.

The high frequency power generating part 35 is configured by a full-bridge circuit including a first element group 35A made of two IGBT elements and a second element group 35B made of two IGBT elements, and is provided to ON/OFF drive each element group 35A, 35B according to the drive control of the drive controlling part 36, generate the high frequency power corresponding to the heating amount up to the target temperature according to the drive content of each element group 35A, 35B, and supply the high frequency power to the heating coil 23 in the heat exchanging apparatus 8. The first element group 35A and the second element group 35B are not simultaneously ON driven.

The first element group 35A and the second element group 35B are configured by the IGBT element, but may be configured by a power transistor, a power MOSFET, and the like. The high frequency power generating part 35 is configured by the full-bridge circuit, but may be configured by a single switch inverter.

The heat exchanging apparatus 8 is configured by an rLC series resonance circuit (primary side coil 41A and capacitor 41B) 41 corresponding to the heating coil 23, a secondary side coil 42 corresponding to the heat generating tube 21, and a resistor 43 corresponding to the short-circuit member 22, where the rLC series resonance circuit 41 generates the primary side magnetic flux according to the high frequency power from the high frequency power generating part 35 of the driver unit 12, generates the secondary side magnetic flux at the secondary side coil 42 (heat generating tube 21) with the primary side magnetic flux, and generates the electromagnetic induction power at the heat generating tube 21 with the primary side magnetic flux and the secondary side magnetic flux; and the resistor 43 (short-circuit member 22) generates the short-circuit current according to the electromagnetic induction power and heats the secondary side coil 42 (heat generating tube 21) according to the short-circuit current. As a result, the heat generating tube 21 temperature adjusts the ultrapure water so that the temperature of the ultrapure water flowing through the tube becomes a target temperature according to the temperature adjustment effect of the short-circuit current.

The primary side coil 41A of the rLC series resonance circuit 41 corresponding to the heating coil 23 and the secondary side coil 42 corresponding to the heat generating tube 21 are transformer coupled, but are not in a typical dense coupling but are in a sparse coupling. This is because if the heating coil 23 and the heat generating tube 21 are dense coupled, the heat generating tube 21 itself extension/contraction changes during the heating of the heat generating tube 21 thereby breaking the dense coupling. Therefore, the transformer coupling between the heat generating tube 21 and the heating coil 23 are sparse coupling to respond to extension/contraction change of the heat generating tube 21.

The operation of the semiconductor washing system 1 proposed by the applicant will now be described.

The temperature sensor 10 detects the current temperature of the ultrapure water discharged from the flow-out port 21B of the heat exchanging apparatus 8, and notifies the current temperature to the PLC unit 11.

When the current temperature of the ultrapure water is detected in the temperature sensor 10, the temperature comparing part 11A in the PLC unit 11 compares the current temperature with the target temperature of the ultrapure water set in the temperature adjustment unit 9.

The voltage pulse generating part 11B in the PLC unit 11 generates the voltage pulse corresponding to the heating amount up to the target temperature based on the comparison result of the temperature comparing part 11A, and outputs the voltage pulse to the driver unit 12 through the voltage pulse outputting part 11C.

The drive controlling part 16 in the driver unit 12 provides the drive control signal corresponding to the heating amount up to the target temperature to the high frequency power generating part 35 based on the voltage pulse from the PLC unit 11.

The high frequency power generating part 35 drive controls the first element group 35A and the second element group 35B according to the drive control signal, generates the high frequency power corresponding to the heating amount up to the target temperature according to the drive content, and supplies the high frequency power to the rLC series resonance circuit 41 (heating coil 23) in the heat exchanging apparatus 8.

The rLC series resonance circuit 41 (heating coil 23) generates the primary side magnetic flux according to the high frequency power, generates the secondary side magnetic flux at the heat generating tube 21 (secondary side coil 42) with the primary side magnetic flux, and generates the electromagnetic induction power at the heat generating tube 21 (secondary side coil 42) with the primary side magnetic flux and the secondary side magnetic flux.

The short-circuit member 22 generates the short-circuit current according to the electromagnetic induction power of the heat generating tube 21, and temperature adjusts the heat generating tube 21 according to the short-circuit current. As a result, the heat generating tube 21 temperature adjusts the ultrapure water flowing through the tube according to the temperature adjustment effect of the short-circuit current.

According to the heat exchanging apparatus 8 of the semiconductor washing system 1, the ultrapure water of target temperature is supplied to the washing device 2 at high speed and high accuracy from the flow-out port 21A of the heat generating tube 21 through the second conduction tube 7, so that the washing device 2 washes the target surface with the ultrapure water of target temperature by continuing the feedback control of detecting the current temperature of the ultrapure water, generating the high frequency power corresponding to the heating amount up to the target temperature based on the detected current temperature and the target temperature, and heating the ultrapure water flowing through the heat generating tube 21 according to the high frequency power.

According to the heat exchanging apparatus 8, the heating coil 23 generates the primary side magnetic flux according to the high frequency power, generates the secondary side magnetic flux at the heat generating tube 21 with the primary side magnetic flux, generate the electromagnetic power at the heat generating tube 21 with the primary side magnetic flux and the secondary magnetic flux, generates the short-circuit current in the short-circuit member 22 according to the electromagnetic induction power, heats the heat generating tube 21 according to the temperature adjustment effect of the short-circuit current, and consequently heats the ultrapure water so that the temperature of the ultrapure water flowing through the tube becomes the target temperature, whereby a uniform temperature rise effect is ensured by performing a uniform joule heat exchange effect in the heat generating tube 21 itself, and the same power density is obtained at every portion of the heat generating tube 21 and the short-circuit member 22, and thus alternation and modification of the ultrapure water can be suppressed by suppressing the power density to about less than ⅓ compared to the conventional circulator type heat exchanging apparatus, and stable temperature adjustment of high speed and high accuracy can be ensured.

Furthermore, according to the semiconductor washing system 1, miniaturization of the entire system and great reduction in the power consumption amount are achieved, and as a result, great reduction in the facility cost is realized since special devices such as cooling device and constant temperature liquid circulating device as in the conventional circulator type heat exchanging apparatus are not necessary.

Moreover, according to the semiconductor washing system 1, great reduction in the facility cost is realized by miniaturizing the entire system and reducing the power consumption, and furthermore, a uniform temperature rise effect is ensured by performing a uniform joule heat exchange effect in the heat generating tube 21 itself, and the same power density is obtained at every portion of the heat generating tube 21 and the short-circuit member 22, and thus alternation and modification of the ultrapure water can be suppressed by suppressing the power density to about less than ⅓ compared to the conventional circulator type heat exchanging apparatus, and stable temperature adjustment of high speed and high accuracy can be ensured, compared to the conventional circulator type system, by continuing the feedback control of detecting the current temperature of the ultrapure water at the vicinity of the flow-out port 21B of the heat generating tube 21, generating the high frequency power corresponding to the heating amount up to the target temperature, and heating the ultrapure water flowing through the heat generating tube 21 according to the high frequency power, and discharging the ultrapure water of target temperature from the flow-out port 21B of the heat exchanging apparatus 8 at high speed and high accuracy.

According to the semiconductor washing system 1 proposed by the applicant, after the ultrapure water from the pure water manufacturing device 3 is filtered with the deairing membrane 4, the reverse osmosis membrane 5A, and the UF filter, the filtered ultrapure water is flowed into the first conduction tube 6, but since the water pressure of the ultrapure water on the reverse osmosis membrane 5A is extremely strong when separating and removing the ion components from the ultrapure water with the reverse osmosis membrane 5A, the material components of the reverse osmosis membrane 5A such as acetic ester and polymeric polymer particles might be stripped and produced.

The entire length is a long distance of a few hundred m in the tube of the first conduction tube 6 through which the ultrapure water flows, and thus material components of the first conduction tube 6 such as fluorine polymer particles produce. Although the ultrapure water is pure water removed with impurities to the utmost extent, silica particles (SiO₂) still coexist.

Therefore, the ultrapure water flowing through the tube contain the acetic ester and polymeric polymer particles of the reverse osmosis membrane 5A, the fluorine particles of the first conduction tube 6, the colloid particles such as silica particles coexisting in the ultrapure water, and the like before reaching the flow-in port 21A of the heat generating tube 21 in the heat exchanging apparatus 8 from the pure water manufacturing device 3 through the deairing membrane 4, the revere osmosis membrane 5A, the UF filter, and the first conduction tube 6.

Moreover, since the first conduction tube 6 through which the ultrapure water flows has a porous in-tube wall face and has an entire length of a long length of a few hundred m, and furthermore, the ultrapure water originally contains dissolved oxygen molecules, air bubbles generate in the ultrapure water flowing through the tube from dissolved oxygen molecules, Karman vortex, and the like even if the ultrapure water is filtered with the deairing membrane 4, the reverse osmosis membrane 5A, and the UF filter.

The first conduction tube 6 is an electrical insulator having an electrical resistivity of about 10⁹ Ωcm, whereas the ultrapure water flowing through the first conduction tube 6 has an electrical resistivity of greater than or equal to about 18×10⁶ Ωm, and thus the charge level of the frictional electrification between the first conduction tube 6 and the ultrapure water becomes higher to a few kV to a few dozen kV as the flow rate level of the ultrapure water flowing through the first conduction tube 6 becomes higher, where the in-wall peripheral surface of the first conduction tube 6 is charged with “−” charges and the ultrapure water is charged with “+” charges, and the frictional electrification phenomenon in which the charges concentrate occur at the contacting surface of the first conduction tube 6 and the ultrapure water.

The ultrapure water charged with “+” charges flows a long distance of about 300 m in the tube of the first conduction tube 6, and thus the charged voltage thereof is assumed to rise.

### SUMMARY OF THE INVENTION

According to the heat exchanging apparatus 8 of the semiconductor washing system 1 proposed by the applicant, the ultrapure water is supplied to the flow-in port 21A of the heat generating tube 21 through the first conduction tube 6, the ultrapure water flowing through the heat generating tube 21 is heated according to the high frequency power corresponding to the heating amount up to the target temperature, and the ultrapure water of target temperature is discharged form the flow-out port 21B, but air bubbles generated from the dissolved oxygen molecules of the ultrapure water and Karman vortex involve collide particles due to generation of collide particles such as acetic ester, polymeric polymer particles, fluorine particles, and silica particles, generation of air bubbles due to dissolved oxygen molecules of the ultrapure water and Karman vortex, and occurrence of frictional electrification phenomenon between the ultrapure water and the first conduction tube 6, and furthermore the collide particles 102 or the collide particle 102 and the air bubble 101 attract to each other through the continuously generated frictional electrification charges, and the size of the residual particle component configured by an assembly of air bubbles 101 and collide particles 102 become larger as the electrification charge rises. As a result, when the target surface in the washing device 2 is washed with ultrapure water containing large residual particle components, if the PNP channel width of the target surface is about 45 nm, the residual particle component having a size exceeding about ⅓ (about 15 nm) remains on the target surface after washing with the ultrapure water, thereby leading to yield in the semiconductor mask forming process (exposure process, resist application, stripping process, washing process) or semiconductor wafer circuit forming process, exposure defect and resist film formation defect due to physical attraction (van der Waals attraction) of the residual particle component to the mask and the wafer, and lowering in quality.

Such event occurs not only with chemical solution such as ultrapure water and similarly occurs with chemical gas, where when the chemical gas is flowed through the first conduction tube 6, the clusters or the cluster and the collide particle of the chemical gas attract to each other due to occurrence of frictional electrification phenomenon between the chemical gas and the first conduction tube 6, the size of the cluster assembly configured by an assembly of cluster and collide particle becomes larger as the electrification charge rises, whereby the large cluster assembly adversely affects the semiconductor mask forming process and the semiconductor wafer circuit forming process in various ways.

According to the heat exchanging apparatus 8 of the semiconductor washing system 1, the electrification charges of the ultrapure water rise with occurrence of frictional electrification phenomenon between the ultrapure water and the first conduction tube 6, and thus the charged ultrapure water discharges at the target surface, thereby adversely affecting the semiconductor mask forming process and the semiconductor wafer circuit forming process such as causing microscopic image damage in the semiconductor mask forming process, degradation of insulation and damage of formed element of the circuit of the target surface in the semiconductor wafer circuit forming process.

In view of the above, it is an object of the present invention to provide a heat exchanging apparatus for reliably preventing lowering in quality caused by residual particle component or cluster assembly in the semiconductor mask forming process and the semiconductor wafer circuit forming process and reliably reducing the adverse affect by electrification of chemicals and chemical gas by fining the residual particle component related to chemical solution and cluster assembly related to chemical gas.

In order to achieve the above aim, a heat exchanging apparatus of the present invention relates to a heat exchanging apparatus including a heat generating tube made of conductive material for flowing chemical solution or chemical gas used in a manufacturing process of a semiconductor or a liquid crystal; a short circuit member made of non-magnetic material for electrically short-circuiting ends of the heat generating tube; and a heating coil, arranged to envelope the heat generating tube and the short circuit member, for generating an electromagnetic induction power with respect to the heat generating tube according to a high frequency power, the short circuit member generating a short circuit current according to the electromagnetic power of the heat generating tube and temperature-adjusting the heat generating tube according to the short circuit current, and the heat generating tube temperature-adjusting the chemical solution or the chemical gas so that a temperature of the chemical solution or the chemical gas flowing through the tube becomes a target temperature according to the temperature adjustment effect of the short circuit current, wherein the end of the heat generating tube through which the chemical solution or the chemical gas flows is grounded to discharge electrification charges of a residual particle component related to the chemical solution or a cluster assembly related to the chemical gas flowing through the heat generating tube, and fine the residual particle component or the cluster assembly.

In the heat exchanging apparatus, a vicinity of an inlet of the heat generating tube through which the chemical solution or the chemical gas flows may be grounded as the end of the heat generating tube.

In the heat exchanging apparatus, the heat generating tube may be configured by a turbulent flow generating member for turbulent-flowing the chemical solution or the chemical gas flowing through the tube, the turbulent flow generating member causing turbulent effect of the chemical solution or the chemical gas to discharge the electrification charges of the residual particle component related to the chemical solution or the cluster assembly related to the chemical gas flowing through the heat generating tube, and fine the residual particle component or the cluster assembly.

In the heat exchanging apparatus, the turbulent flow generating member may be configured by twisting substantially a central part to a spiral form, and a ferromagnetic member for magnetically bonding the heat generating tube and the heating coil and being internally inserted into an insertion hole formed by the turbulent flow generating member may be further arranged.

In the heat exchanging apparatus, the residual particle component related to the chemical solution or the cluster assembly related to the chemical gas flowing through the heat generating tube may be fined according to the effect of the electromagnetic induction power and an ultrasonic vibration generated according to the high frequency power to the heating coil.

According to the heat exchanging apparatus of the present invention configured as above, the end of the heat generating tube through which the chemical solution flows is grounded to discharge the electrification charges of the residual particle component related to the chemical solution flowing through the heat generating tube and fine the residual particle component, and thus the frictional electrification charges between the heat generating tube and the chemical solution are discharged and the electrification charges between the collide particles and the air bubbles, which become the cause of enlargement of the residual particle component, are reduced to reduce charge attraction between the collide particles and the air bubbles, thereby reliably preventing lowering in quality caused by the residual particle component in the semiconductor mask forming process and the semiconductor wafer circuit forming process and reliably alleviating the adverse affect by the electrification of chemical solution.

Similarly, according to the heat exchanging apparatus of the present invention, the end of the heat generating tube through which the chemical gas flows is grounded to discharge the electrification charges of the cluster assembly related to the chemical gas flowing through the heat generating tube and fine the cluster assembly, and thus the frictional electrification charges between the heat generating tube and the chemical gas are discharged and the electrification charges between the clusters and between the clusters and the collide particles, which become the cause of enlargement of the cluster assembly, are reduced to reduce charge attraction between the clusters and between the clusters and the collide particles, thereby reliably preventing lowering in quality caused by the cluster assembly in the semiconductor mask forming process and the semiconductor wafer circuit forming process and reliably alleviating the adverse affect by the electrification of chemical gas.

### BRIEF DESCRIPTION OF THE DRAWINGS

FIG. 1 shows an explanatory view showing a cross sectional configuration of the inside of a heat exchanging apparatus, which is a main part, inside a semiconductor washing system showing an embodiment related to the heat exchanging apparatus of the present invention;

FIG. 2 shows an explanatory view simply showing change in residual particle component of the heat exchanging apparatus of the present embodiment;

FIG. 3 shows an explanatory view simply showing turbulent effect inside a heat generating tube in the heat exchanging apparatus of the present embodiment;

FIG. 4 shows an explanatory view simply showing change in size of the residual particle component at a flow-in port and a flow-out port of the heat exchanging apparatus of the present embodiment;

FIG. 5 shows a block diagram showing a schematic configuration of the inside of a semiconductor washing system describing an embodiment of a heat exchanging apparatus of the prior art proposed by the applicant;

FIG. 6 shows an explanatory view showing a substantially cross sectional structure of the inside of the heat exchanging apparatus of the prior art proposed by the applicant;

FIG. 7 shows an explanatory view showing a configuration of the inside of a PLC unit, a driver unit, and the heat exchanging apparatus of the prior art proposed by the applicant from an electrical standpoint;

FIG. 8 shows an explanatory view simply showing frictional electrification charge in a first conduction tube of the semiconductor washing system of the prior art proposed by the applicant; and

FIG. 9 shows an explanatory view simply showing change in residual particle component of the semiconductor washing system of the prior art proposed by the applicant.

### DETAILED DESCRIPTION OF THE PREFERRED EMBODIMENTS

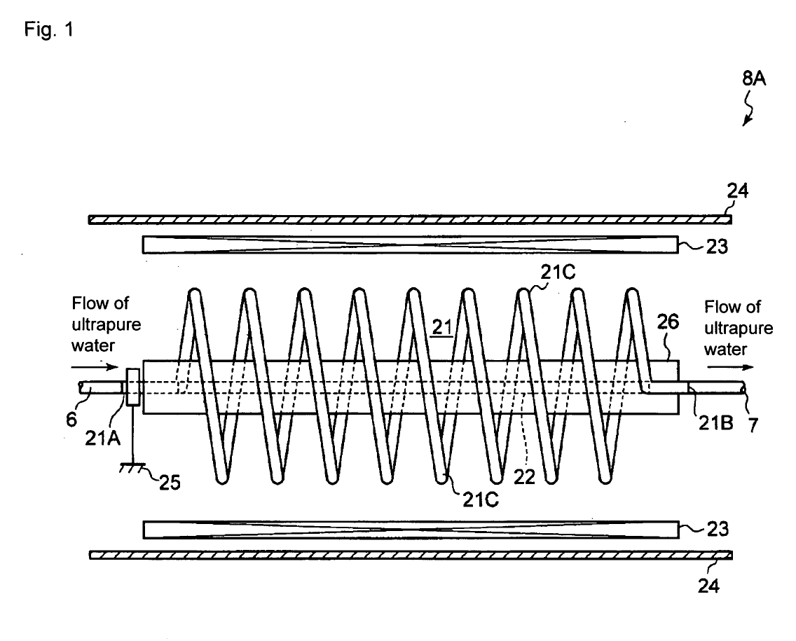

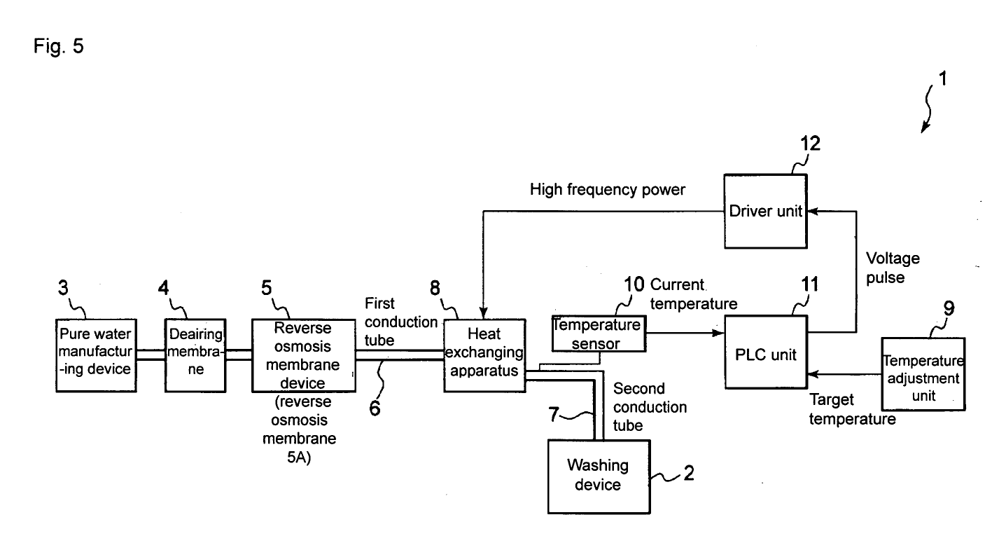

A semiconductor washing system showing embodiments related to the heat exchanging apparatus of the present invention will now be described based on the drawings. FIG. 1 shows an explanatory view showing a schematic cross sectional structure of the inside of the heat exchanging apparatus according to the present embodiment. Configurations redundant with the semiconductor washing system 1 shown in FIG. 5 are denoted with the same reference numerals, and the description on the redundant configuration and the operation will be omitted.

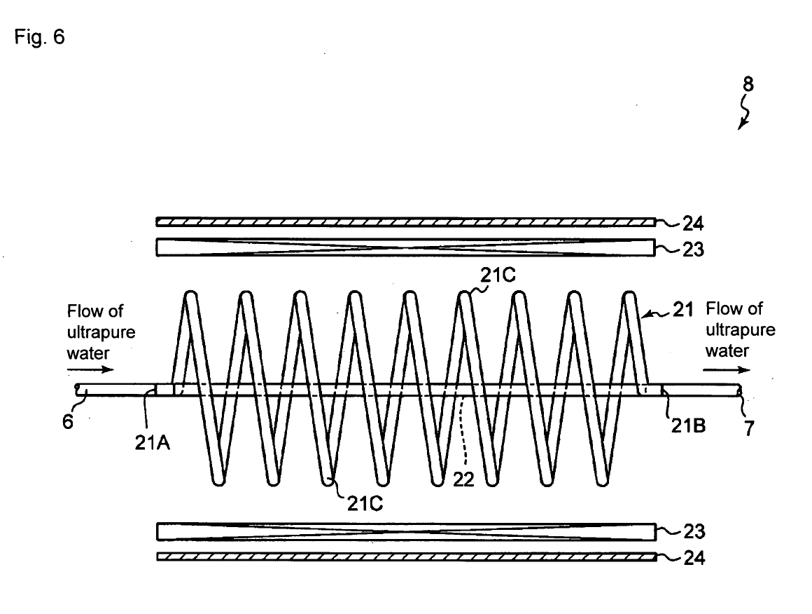

The heat exchanging apparatus 8A shown in FIG. 1 and the heat exchanging apparatus 8 shown in FIG. 6 differ in that the vicinity of the flow-in port 21A of the heat generating tube 21 is grounded at the earth 25 to discharge the frictional electrification charges of the residual particle component related to the ultrapure water flowing through the heat generating tube 21 and reduce the electrification charges between the collide particles and the air bubbles, which become the cause of enlargement of the residual particle component, thereby reducing charge attraction between the collide particles and the air bubbles and fining the residual particle component, and reliably alleviating the adverse affect by the electrification of the ultrapure water.

The heat exchanging apparatus 8A includes a ferromagnetic member 26 for magnetically coupling the heat generating tube 21 and the heating coil 23, which ferromagnetic member 26 is internally inserted to an insertion hole 21D formed by a spiral part 21C of the heat generating part 21 to converge the secondary side magnetic flux and the secondary side leakage magnetic flux of the heat generating tube 21 generated according to the high frequency power from the driver unit 12 and fine the residual particle component related to the ultrapure water flowing through the heat generating tube 21 according to the effect of the electromagnetic induction power and the ultrasonic vibration generated according to the high frequency power.

The spiral part 21C of the heat generating tube 21 exhibits turbulent effect by impacting the ultrapure water flowing in from the first conduction tube 6 against the in-tube wall face, breaks up the residual particle component with the turbulent effect and fines the residual particle component while achieving neutralization effect of the ultrapure water by impacting the “+” electrification charges of the residual particle component to the “−” electrification charges of the in-tube wall face and discharging the same, and furthermore, breaks up and uniformly fines the residual particle component according to the effect of the electromagnetic induction power and the ultrasonic vibration. A uniform temperature rise effect is ensured according to the turbulent effect of the ultrapure water of the spiral part 21C.

A heat exchanging apparatus described in the Claims corresponds to the heat exchanging apparatus 8A, a heat generating tube to the heat generating tube 21, a short-circuit member to the short-circuit member 22, a heating coil to the heating coil 23, a ferromagnetic member to the ferromagnetic member 26, an insertion hole to the insertion hole 21D, a ground to the earth 25, and a turbulent flow generating member to the spiral part 21C of the heat generating tube 21.

The operation of the heat exchanging apparatus 8A according to the embodiment will now be described with reference to FIGS. 1, 5, and 7.

The pure water manufacturing device 3 separates and removes the gas component of the ultrapure water through the deairing membrane 4, separates and removes the ion component of the ultrapure water separated and removed with gas component through the reverse osmosis membrane 5A, and filters the ultrapure water removed and separated with the ion component with the UF filter, and flows the ultrapure water filtered through the deairing membrane 4, the reverse osmosis membrane 5A, and the UF filter into the first conduction tube 6.

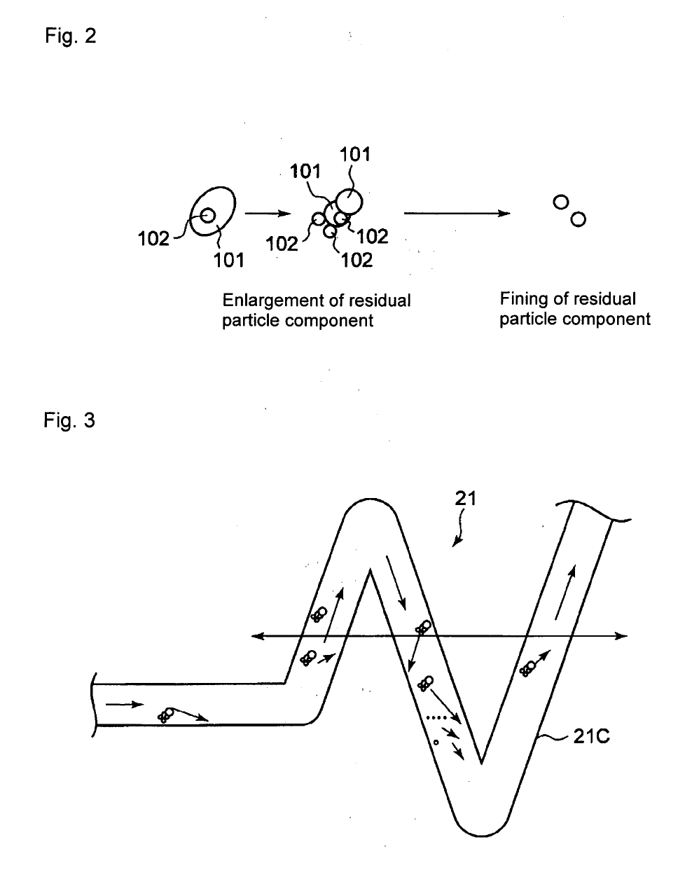

In this case, the ultrapure water flowed into the first conduction tube 6 has the collide particle 102 containing polymeric polymer particle stripped at the reverse osmosis membrane 5A by water pressure of the ultrapure water, fluorine particle of the first conduction tube 6, silica particle coexisting in the ultrapure water involved in the air bubble 101 generated from the dissolved oxygen molecule of the ultrapure water and Karman vortex, where frictional electrification charges are generated between the in-tube wall face of the first conduction tube 6 and the ultrapure water, the electrification charges between the collide particle 102 and the air bubbles 101 attract to each other with the frictional electrification charges, and the size of the residual particle component configured by an assembly of the air bubble 101 and the collide particle 102 enlarges as the electrification charges rise, as shown in FIG. 2.

The temperature sensor 10 shown in FIG. 5 detects the current temperature of the ultrapure water discharged from the flow-out port 21B of the heat exchanging apparatus 8A, and notifies the current temperature to the PLC unit 11.

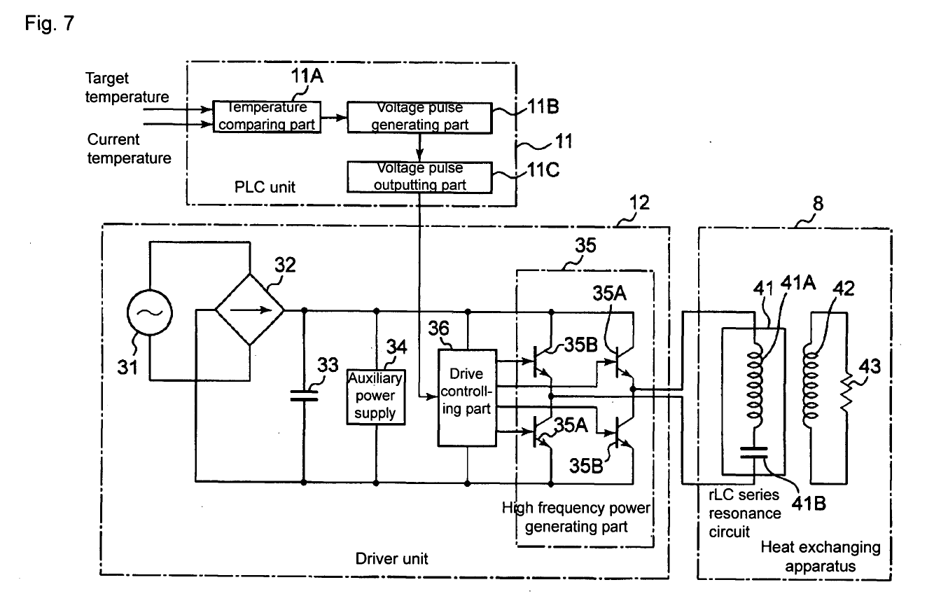

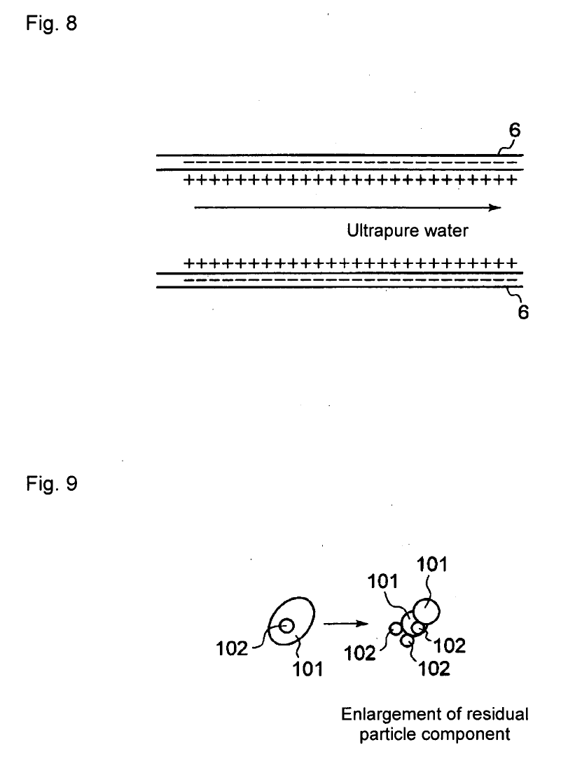

When the current temperature of the ultrapure water is detected by the temperature sensor 10, the temperature comparing part 11A in the PLC unit 11 shown in FIG. 7 compares the current temperature and the target temperature of the ultrapure water set in the temperature adjustment unit 9.

The voltage pulse generating part 11B in the PLC unit 11 generates the voltage pulse corresponding to the heating amount up to the target temperature based on the comparison result of the temperature comparing part 11, and outputs the voltage pulse to the driver unit 12 through the voltage pulse outputting part 11C.

The drive controlling part 36 of the driver unit 12 provides the drive control signal corresponding to the heating amount up to the target temperature to the high frequency power generating part 35 based on the voltage pulse from the PLC unit 11.

The high frequency power generating part 35 drive controls the first element group 35A and the second element group 35B according to the drive control signal, generates the high frequency power corresponding to the heating amount up to the target temperature according to the drive content, and supplies the high frequency power to the rLC series resonance circuit 41 (heating coil 23) in the heat exchanging apparatus 8A. The high frequency power may have an operation frequency of greater than or equal to 20 kHz such as operation frequency of around 52 kHz.

The rLC series resonance circuit 41 (heating coil 23) generates the primary side magnetic flux according to the high frequency power, and generates the secondary side magnetic flux at the heat generating tube 21 (secondary side coil 42) with the primary side magnetic flux.

The ferromagnetic member 26 converges the secondary side leakage magnetic flux generated for every turn of the spiral part 21C of the heat generating tube 21 to the secondary side magnetic flux, and converges the converged secondary side magnetic flux and the primary side magnetic flux of the heating coil 23.

As a result, the ferromagnetic member 26 increases the self-inductance of the heat generating tube 21 by converging the secondary side magnetic flux and the secondary side leakage magnetic flux of the heat generating tube 21.

The short-circuit member 22 generates the short-circuit current corresponding to the generation amount of the electromagnetic induction power corresponding to the self inductance according to increase in self-inductance of the heat generating tube 21, and temperature adjusts the heat generating tube 21 according to the short-circuit current. As a result, the heat generating tube 21 temperature adjusts the ultrapure water flowing through the tube according to the temperature adjustment effect of the short-circuit current.

The heat generating tube 21 of the heat exchanging apparatus 8A reduces the electrification charges between the collide particles 102 and the air bubbles 101, which becomes the cause of enlargement of the residual particle component, and fines the residual particle component as the ultrapure water charged with “+” charges is discharged since the vicinity of the flow-in port 21A of the heat generating tube 21 is grounded to the earth 25 when the ultrapure water containing the residual particle component flows in from the first conduction tube 6, and reliably alleviates the adverse affect involved in electrification of the ultrapure water by neutralizing the electrification of the ultrapure water.

Furthermore, when the ultrapure water containing the residual particle component flows through the tube of the spiral part 21C, as shown in FIG. 3, the heat generating tube 21 impacts the ultrapure water charged to “+” charges against the in-tube wall face charged to “−” charges and discharges the same according to the turbulent effect of the ultrapure water, thereby reducing the electrification charges between the collide particles 102 and the air bubbles 101 and fining residual particle component.

The heat exchanging apparatus 8A generates the electromagnetic induction power at the heating coil 23 according to the high frequency power of around 52 kHz from the driver unit 12, and thus breaks up the residual particle component contained in the ultrapure water according to the electromagnetic induction power effect of the high frequency power and the ultrasonic vibration, and fines the residual particle component up to the size of less than about ⅓ of the PNP channel width or 45 nm etc. of the target surface in the washing device 2, thereby reliably preventing the adverse affect of the residual particle component in the semiconductor mask forming process and the semiconductor wafer circuit forming process even if the target surface is washed with the relevant ultrapure water.

Consequently, the heat exchanging apparatus 8A temperature adjusts the ultrapure water containing the residual particle component from the first conduction tube 6 up to the target temperature in the heat generating tube 21, fines the residual particle component contained in the temperature adjusted ultrapure water and supplies the same to the washing device 2 through the second conduction tube 7, so that the ultrapure water of target temperature is ejected to the target surface through the second conduction tube 7 to wash the target surface in the washing device 2.

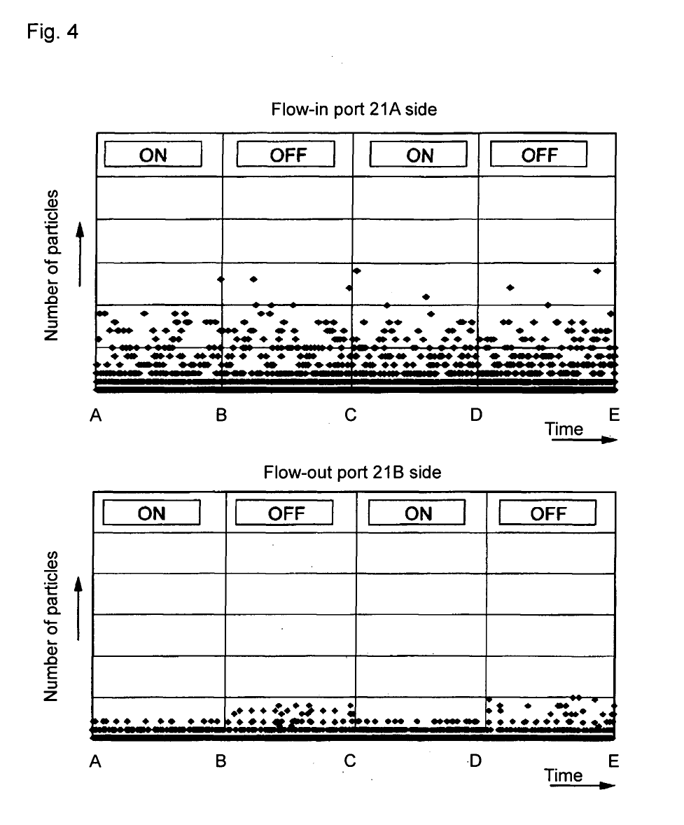

FIG. 4 shows an explanatory view comparing the size of the residual particle component contained in the ultrapure water at the flow-in port 21A side and the flow out port 21B side of the heat generating tube 21. The heat exchanging apparatus 8A is turned ON from A to B, the heat exchanging apparatus 8A is turned OFF from B to C, the heat exchanging apparatus 8A is turned ON from C to D, and the heat exchanging apparatus 8A is turned OFF from D to E; where the size of the residual particle component contained in the ultrapure water at the flow-in port 21A side of the ultrapure water containing the residual particle component flowing into the heat generating tube 21 through the first conduction tube 6 and the flow-out port 21B side for discharging the ultrapure water containing the residual particle component is compared.

The example of FIG. 4 corresponds to the data of when the heat exchanging apparatus 8A according to the present embodiment including the spiral part 21C of the heat generating tube 21, ground to the earth 25, and the ferromagnetic member 26 inserted in the insertion hole 21D configured by the spiral part 21C is used, where the size of the residual particle component on the flow-out port 21B side is found to be extremely fined compared to the size of the residual particle component on the flow-in port 21A side focusing on A, B, C, D, and E.

In the example of FIG. 4, the heat exchanging apparatus 8A including the spiral part 21C, the earth 25, and the ferromagnetic member 26 has been described by way of example, but it is apparent that the residual particle component on the flow-out port 21B side is similarly fined compared to the residual particle component on the flow-in port 21A side even when a heat exchanging apparatus including the spiral part 21C and the earth 25 is used (heat exchanging apparatus without the ferromagnetic member 26).

Similarly, it is apparent that the residual particle component on the flow-out port 21B side is similarly fined compared to the residual particle component on the flow-in port 21A side even when the heat exchanging apparatus in which the heat generating tube 21 of a linear tube without the spiral part 21C is used and the earth 25 is arranged is used (heat exchanging apparatus without the ferromagnetic member 26).

In other words, according to the present embodiment, the vicinity of the flow-in port 21A of the heat generating tube 21 through which the ultrapure water flows is grounded to the earth 25 to discharge the electrification charges of the residual particle component related to the ultrapure water flowing through the heat generating tube 21 and fine the residual particle component, thereby discharging the frictional electrification charges between the heat generating tube 21 and the ultrapure water and reducing the electrification charges between the collide particles and the air bubbles, which become the cause of enlargement of the residual particle component, to reduce the charge attraction between the collide particles and the air bubbles and fine the residual particle component, so that lowering in quality caused by the residual particle component in the semiconductor mask forming process and the semiconductor wafer circuit forming process is reliably prevented, and the adverse affect by the electrification of the ultrapure water is reliably alleviated.

According to the present embodiment, the heat generating tube 21 is configured by the spiral part 21C for turbulent-flowing the ultrapure water flowing through the tube, where the electrification charges of the residual particle component related to the ultrapure water flowing through the tube of the spiral part 21C are discharged according to the turbulent effect of the ultrapure water by the spiral part 21C so that the electrification charges thereof become substantially zero and the residual particle component is fined, and thus the residual particle component of “+” charges impacts the in-tube wall face of “−” charges by the turbulent effect of the ultrapure water in the spiral part 21C thereby discharging the electrification charges of the residual particle component and fining the residual particle component, and reliably alleviating the adverse affect by the electrification of the ultrapure water.

According to the embodiment, the ferromagnetic member 26 for magnetically bonding the heat generating tube 21 and the heating coil 23 is internally inserted to the insertion hole 21D configured by the spiral part 21C, and thus the self-inductance of the heat generating tube 21 can be increased without increasing the number of turns of the heat generating tube 21 serving as the secondary coil, and as a result, the generation amount of the electromagnetic induction power can be increased without enlarging, the ferromagnetic member 26 increases the effect of Lorentz force on the residual particle component, and furthermore, significantly enhances the uniform fining effect of the residual particle component with magnetic annihilation of the zener potential.

According to the present embodiment, the residual particle component related to the ultrapure water flowing through the heat generating tube 21 is fined according to the electromagnetic induction power and the ultrasonic vibration generated according to the high frequency power of around 52 kHz to the heating coil 23, and thus the breaking effect and the uniform fining effect of the residual particle component can be enhanced according to the electromagnetic induction power effect and the ultrasonic vibration effect.

In the above embodiment, the spiral part 21C is formed by twisting the heat generating tube 21 as the turbulent flow generating member, but obviously, similar effects are obtained by being formed by the turbulent flow generating member such as static mixer.

In the above embodiment, the semiconductor washing system 1 in which ultrapure water is used as the chemical solution, and the ultrapure water is ejected onto the target surface arranged in the washing device 2 through the second conduction tube 7 to wash the target surface is described by way of example, but obviously, similar effects are obtained with a semiconductor manufacturing system such as developing solution heating system in which developing solution is used as the chemical solution and the developing solution is applied to the target surface.

In the above embodiment, the current temperature of the ultrapure water and the target temperature is compared in the PLC unit 11, the voltage pulse corresponding to the heating amount up to the target temperature of the ultrapure water is output to the heat exchanging apparatus 8A based on the comparison result, and the driver unit 12 outputs the high frequency power corresponding to the heating amount up to the target temperature of the ultrapure water based on the voltage pulse, but obviously, similar effects are obtained when current (4 to 20 mA/0 to 10 mA) corresponding to the heating amount up to the target temperature of the ultrapure water is output to the heat exchanging apparatus 8A instead of the voltage pulse of the PLC unit 11, and the driver unit 12 outputs high frequency power corresponding to the heating amount up to the target temperature of the ultrapure water based on the current.

The semiconductor washing system 1 using ultrapure water as the chemical solution has been described in the above embodiment, but the present invention is also applicable to a system using chemical gas instead of chemical solution, in which case, the ends of the heat generating tube through which the chemical gas flows are grounded to discharge the electrification charges of the cluster assembly related to the chemical gas flowing through the heat generating tube and fine the cluster assembly, and thus the frictional electrification charges between the heat generating tube and the chemical gas are discharged, and the electrification charges between the clusters and between the clusters and the collide particles of the chemical gas, which become the cause of enlargement of the cluster assembly, are reduced to reduce charge attraction between the clusters and between the clusters and the collide particles and fine the cluster assembly, thereby reliably preventing lowering in quality caused by cluster assembly in the semiconductor mask forming process and the semiconductor wafer circuit forming process, and reliably alleviating the adverse affect by the electrification of the chemical gas.

The semiconductor manufacturing process is described in the above embodiment by way of example, but similar effects are obviously obtained in the liquid crystal substrate manufacturing process.

According to the heat exchanging apparatus of the present invention, the electrification charges between the collide particles and the air bubbles, which become the cause of enlargement in the residual particle related to the chemical solution flowing through the heat generating tube, is discharged by grounding the end of the heat generating tube through which the chemical solution flows, and the charge attraction between the collide particle and the air bubble is reduced to fine the size of the residual particle component, and thus the present invention is effective in the semiconductor washing system of temperature-adjusting the chemical solution such as ultrapure water to the target temperature, and ejecting the temperature adjusted ultrapure water to wash the target surface of the semiconductor therewith.

What is claimed is:

1. A heat exchanging apparatus comprising:
a heat generating tube made of conductive material for flowing chemical solution or chemical gas used in a manufacturing process of a semiconductor or a liquid crystal;
a short circuit member made of non-magnetic material for electrically short-circuiting ends of the heat generating tube; and
a heating coil, arranged to envelope the heat generating tube and the short circuit member, for generating an electromagnetic induction power with respect to the heat generating tube according to a high frequency power, the short circuit member generating a short circuit current according to the electromagnetic power of the heat generating tube and temperature-adjusting the heat generating tube according to the short circuit current, and the heat generating tube temperature-adjusting the chemical solution or the chemical gas so that a temperature of the chemical solution or the chemical gas flowing through the tube becomes a target temperature according to the temperature adjustment effect of the short circuit current, wherein
the end of the heat generating tube through which the chemical solution or the chemical gas flows is grounded to discharge electrification charges of a residual particle component related to the chemical solution or a cluster assembly related to the chemical gas flowing through the heat generating tube, and fine the residual particle component or the cluster assembly.

2. The heat exchanging apparatus according to claim 1, wherein a vicinity of an inlet of the heat generating tube through which the chemical solution or the chemical gas flows is grounded as the end of the heat generating tube.

3. The heat exchanging apparatus according to claim 1, wherein the heat generating tube is configured by a turbulent flow generating member for turbulent-flowing the chemical solution or the chemical gas flowing through the tube, the turbulent flow generating member causing turbulent effect of the chemical solution or the chemical gas to discharge the electrification charges of the residual particle component related to the chemical solution or the cluster assembly related to the chemical gas flowing through the heat generating tube, and fine the residual particle component or the cluster assembly.

4. The heat exchanging apparatus according to claim 3, wherein the turbulent flow generating member is configured by twisting substantially a central part to a spiral form, further comprising a ferromagnetic member for magnetically bonding the heat generating tube and the heating coil being internally inserted into an insertion hole formed by the turbulent flow generating member.

5. The heat exchanging apparatus according to claim 1, wherein the residual particle component related to the chemical solution or the cluster assembly related to the chemical gas flowing through the heat generating tube is fined according to the effect of the electromagnetic induction power and an ultrasonic vibration generated according to the high frequency power to the heating coil.
